(19) United States
(12) Patent Application Publication
(10) Pub. No.: US 2020/0058950 A1
(43) Pub. Date: Feb. 20, 2020

(54) BATTERY DEVICE

(71) Applicant: Yuzo KAWAMURA, Yasu-shi (JP)

(72) Inventor: Yuzo KAWAMURA, Yasu-shi (JP)

(21) Appl. No.: 16/078,223

(22) PCT Filed: Feb. 5, 2018
(86) PCT No.: PCT/JP2018/003718

§ 371 Date: Aug. 21, 2018

(30) Foreign Application Priority Data
Dec. 21, 2017 (JP) 2017-005747

(51) Int. Cl. H01M 8/04858; H01M 8/04276; H01M 8/18

(52) U.S. Cl. CPC H01M 8/04873; H01M 8/188; H01M 8/04276

(57) ABSTRACT

A battery device having a relatively simple configuration and capable of obtaining a battery output, including a battery container storing a battery solution including an electrolytic solution and a heavy water, an electrolytic anode and cathode that electrolyze a battery solution, an acceleration anode and cathode that accelerate positively charged ions in a battery solution, a collecting anode and cathode that collect charges, an electrolytic power source device that applies electrolytic voltage, and an acceleration power source device that applies acceleration voltage. After applying an electrolytic voltage, when the acceleration power source device applies an acceleration voltage, positively charged ions flow from the acceleration anode to the acceleration cathode, and a collector charge flows from the collecting anode to the collecting cathode through a collector connection line for canceling out the positively charged ions gathered at the acceleration cathode. Part of the collector charge is extracted as a battery output.

### TECHNICAL FIELD

The present invention relates to a battery device for obtaining a battery output using a battery solution.

### BACKGROUND

There has been proposed a variety of battery devices, and one of those is fuel cell devices which use fuels and are put into practical use (see Japanese Patent-Application Publication No. HEI-9-266005, for example). Fuel cell devices include a fuel cell main body that generates electricity through a fuel cell reaction, an air supply system that supplies air (including oxygen) to an oxidant electrode of the fuel cell main body, and a fuel gas supply system that supplies fuel gas to a fuel electrode of the fuel cell main body. In the fuel cell main body, chemical energy of fuel gas is directly converted into electric energy through the fuel cell reactions.

These fuel cell devices use methanol, for example, as a fuel, and the fuel gas supply system includes a still that heats the methanol to vaporizes the same, a reformer that reforms the vaporized methanol to generate reformed gas, and a carbon monoxide transformer that lowers the density of carbon monoxide in the reformed gas. The reformed gas with thus lowered carbon monoxide density is supplied to the fuel electrode of the fuel cell main body.

### SUMMARY

### Problems to be Solved by the Invention

The fuel cell devices described above require the still that vaporizes the fuel (methanol), the reformer that reforms the vaporized fuel, the carbon monoxide transformer that lowers the density of carbon monoxide in the reformed gas, and the like. Thus, there are problems that the entire devices are large in size and manufacturing cost is high.

It is an object of the present invention to provide battery devices that have a relatively simple configuration and are capable of obtaining a battery output.

### Means to Solve the Problems

A battery device according to an aspect of the invention includes a battery container that stores a battery solution including an electrolytic solution and a heavy water, an electrolytic anode and an electrolytic cathode that electrolyze the battery solution to ionize the electrolytic solution, thereby generating positively charged ions, an electrolytic power source device that applies an electrolytic voltage between the electrolytic anode and the electrolytic cathode, an acceleration anode and an acceleration cathode disposed within the battery container that accelerate and make the positively charged ions in the battery solution move, an acceleration power source device that applies an acceleration voltage between the acceleration anode and the acceleration cathode, and a collecting anode and a collecting cathode for collecting charges, wherein: the collecting anode is disposed outside the acceleration anode; the collecting cathode is disposed outside the acceleration cathode; the collecting anode and the collecting cathode are electrically connected to each other through a collector connection line disposed outside the battery container; and when an acceleration voltage is applied between the acceleration anode and the acceleration cathode, then the positively charged ions flow from the acceleration anode to the acceleration cathode and gather at the acceleration cathode, and a collector charge flows from the collecting anode to the collecting cathode through the collector connection line for canceling out the positively charged ions gathered at the acceleration cathode, and a part of the collector charge flowing through the collector connection line is extracted as a battery output.

According to another aspect of the invention, the battery device preferably further includes a homogenizing device that homogenizes the battery solution.

According to still another aspect of the invention, the homogenizing device preferably includes a reservoir disposed outside an end wall of the battery container, a solution circulation channel for circulating the battery solution through the reservoir, and a circulating pump disposed to the solution circulation channel, and the battery solution in the battery container circulates through the solution circulation channel and the reservoir, and the flow of the battery solution circulating through the solution circulation channel circulates the battery solution in the battery container.

### Effects of the Invention

According to a battery device of an aspect of the invention, when positively charged ions gather at the acceleration cathode, a collector charge flows from the collecting anode to the collecting cathode through the collector connection line for canceling out the positively charged ions, and a part of thus flowing collector charge can be extracted as the battery output.

According to a battery device of another aspect of the invention, because the homogenizing device is provided, the battery solution in the battery container is homogenized. Thus, a battery output can be obtained stably.

### BRIEF DESCRIPTION OF THE DRAWINGS

FIG. 1 is a cross-sectional view of a battery device according to a first embodiment of the invention.

FIG. 2 is a cross-sectional view of relevant parts of a battery device according to a second embodiment of the invention.

FIG. 3 is a perspective view of an acceleration anode of the battery device of FIG. 2.

FIG. 4 is a cross-sectional view of relevant parts of a battery device according to a third embodiment of the invention.

FIG. 5 is a cross-sectional view of a battery device according to a fourth embodiment of the invention.

FIG. 6 is a simplified block diagram of an entire battery device according to a fifth embodiment of the invention.

FIG. 7 is a cross-sectional view of a battery device used in a verification experiment.

FIG. 8 is a view of a battery device modified after a demonstration experiment.

FIG. 9 is a view showing a condition of sparks occurred in a past experiment.

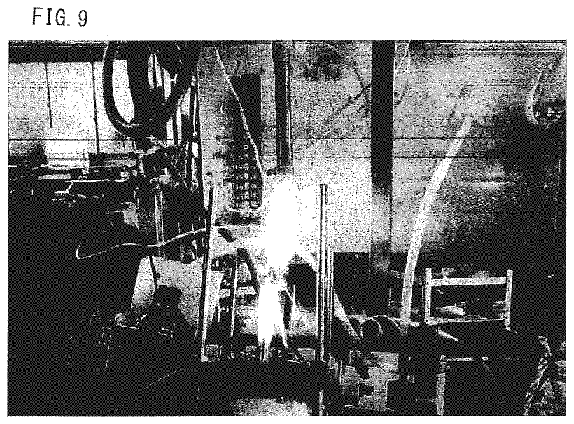

FIG. 10 is a view showing the state in the battery container in the condition of FIG. 9.

### DETAILED DESCRIPTION

### First Embodiment

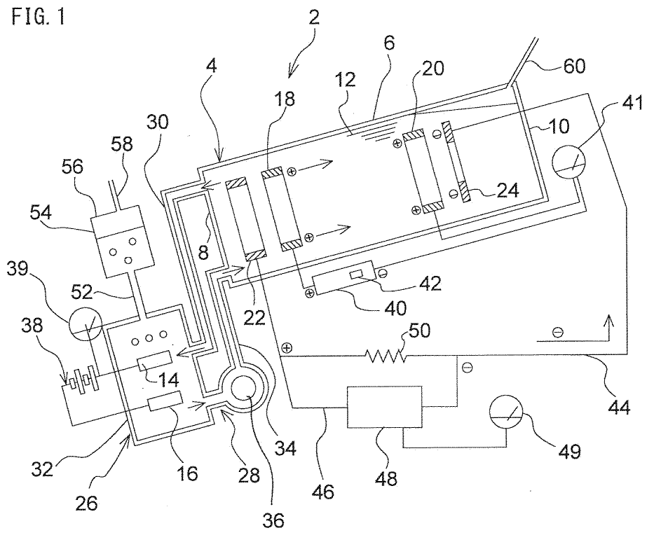

With reference to FIG. 1, a battery device according to a first embodiment of the invention will be described. A battery device 2 shown in FIG. 1 includes a battery container 4. The battery container 4 has a cylindrical body 6 that is long sideways and a pair of lid members 8, 10 disposed at either end of the cylindrical body 6. The battery container 4 is attached to a device frame (not shown) in a tilting state such that the lid member 8 is positioned on the lower side and the lid member 10 is positioned on the upper side as shown in FIG. 1, for example. The battery container 4 is filled with a battery solution 12.

The battery device 2 further includes a reservoir 26 disposed outside the lid member 8 (end wall) of the battery container 4. The reservoir 26 is fluidly connected to the battery container 4 through a solution circulation channel 28. The solution circulation channel 28 has an upstream part 30 and a downstream part 34. The upstream part 30 has an end fluidly connected to the battery container 4 through an upper part of the lid member 8 and another end fluidly connected to the reservoir 26 through an upper part of a peripheral side wall 32 of the reservoir 26. The downstream part 34 has an end fluidly connected to the battery container 4 through a lower part of the lid member 8 and another end fluidly connected to the reservoir 26 through a lower part of the peripheral side wall 32 of the reservoir 26. The downstream part 34 of the solution circulation channel 28 is disposed with a circulating pump 36. It should be noted that in a different embodiment the circulating pump 36 is preferably disposed at the upstream part 30 of the solution circulation channel 28.

The battery device 2 further includes an electrolytic anode 14 and an electrolytic cathode 16 for electrolyzing the battery solution 12, an electrolytic power source device 38 for applying an electrolytic voltage to the electrolytic anode 14 and the electrolytic cathode 16, an acceleration anode 18 and an acceleration cathode 20 for accelerating charged ions in the battery solution 12, an acceleration power source device 40 for applying an acceleration voltage to the acceleration anode 18 and the acceleration cathode 20, and a collecting anode 22 and a collecting cathode 24 for collecting a collector charge and extracting the same as a battery output.

The electrolytic anode 14 and the electrolytic cathode 16 are disposed in confrontation with each other within the reservoir 26. A positive terminal of the electrolytic power source device 38 is electrically connected to the electrolytic anode 14, and a negative terminal thereof is electrically connected to the electrolytic cathode 16. The electrolytic anode 14 and the electrolytic cathode 16 are formed of, for example, plate-like electrodes in the shape of a rectangle or a circle.

It should be noted that in a different embodiment of the invention, the electrolytic anode 14 and the electrolytic cathode 16 are preferably disposed in the battery container 4. In this case, the electrolytic anode 14 and the electrolytic cathode 16 are disposed outside the collecting anode 22 described later (in this embodiment, between the collecting anode 22 and the lid member 8).

In this configuration, when the circulating pump 36 is activated, then the battery solution 12 in the battery container 4 circulates through the solution circulation channel 28 and the reservoir 26 as indicted by an arrow in FIG. 1. Thus circulating battery solution circulates the battery solution within the battery container 4, homogenizing the battery solution in the battery container 4. That is, the reservoir 26, the solution circulation channel 28, and the circulating pump 36 together function as a homogenizing device. Also, when the electrolytic power source device 38 is activated, then an electrolytic voltage is applied between the electrolytic anode 14 and the electrolytic cathode 16, and the battery solution 12 (electrolytic solution within the battery solution 12) is electrolyzed between the electrolytic anode 14 and the electrolytic cathode 16. The electrolyzed and ionized battery solution flows into the battery container 4 through the downstream part 34 of the solution circulation channel 28.

The acceleration anode 18 and the acceleration cathode 20 are disposed in confrontation with each other in a longitudinal direction of the battery container 4 (in a direction from a lower right to an upper left in FIG. 1) within the battery container 4 and immersed in the battery solution 12 within the battery container 4. More specifically, the acceleration anode 18 is disposed inside the lid member 8, and the acceleration cathode 20 is disposed inside the lid member 10. The acceleration anode 18 is electrically connected with a positive terminal of the acceleration power source device 40, and the acceleration cathode 20 is electrically connected with a negative terminal of the acceleration power source device 40. The acceleration anode 18 is formed of, for example, a ring-shaped electrode, a meth-like electrode, or the like. Also, the acceleration cathode 20 is formed of, for example, a ring-shaped electrode or the like.

The acceleration power source device 40 has an acceleration voltage adjustor 42 for adjusting the acceleration voltage to be applied between the acceleration anode 18 and the acceleration cathode 20. The acceleration voltage adjustor 42 adjusts the acceleration voltage such that the voltage of the battery output to be described later becomes lower than the acceleration voltage applied by the acceleration power source device 40, thereby stabilizing the operation state of the battery device 2.

In this configuration, when the acceleration power source device 40 is activated, then the acceleration voltage is applied between the acceleration anode 18 and the acceleration cathode 20, and positively charged ions flow from the acceleration anode 18 toward the acceleration cathode 20 through the battery solution (more specifically, ionized electrolytic solution in the battery solution). The battery output is extracted as will be described later by utilizing this flow of the positively charged ions.

The collecting anode 22 and the collecting cathode 24 are disposed inside the battery container 4 and immersed in the battery solution 12 in the battery container 4. More specifically, the collecting anode 22 is disposed outside the acceleration anode 18 (in this embodiment, between the acceleration anode 18 and the lid member 8), and the collecting cathode 24 is disposed outside the acceleration cathode 20 (in this embodiment, between the acceleration cathode 20 and the lid member 10). In other words, the acceleration anode 18 and the acceleration cathode 20 are disposed between the collecting anode 22 and the collecting cathode 24. The collecting anode 22 and the collecting cathode 24 are formed of, for example, ring-shaped electrodes, plate-shaped electrodes, or the like.

The collecting anode 22 and the collecting cathode 24 are electrically connected to each other through a collector connection line 44 disposed outside the battery container 4. The collector connection line 44 is electrically connected with an external power load 48 through a power output line 46. The collector connection line 44 is disposed with a variable resistance 50, and the power output line 46 is disposed electrically parallel to the variable resistance 50. With this configuration, a part of the collector charge that flows from the collecting anode 22 through the collector connection line 44 into the collecting cathode 24 can be extracted as the battery output and consumed at the external power load 48.

The reservoir 26 is connected to a gas separator 54 through a communicating tube 52, and an outlet duct 58 is connected to an upper wall 56 of the gas separator 54. Thus, gas generated in the electrolysis process by the electrolytic anode 14 and the electrolytic cathode 16 in the reservoir 26 flows through the communicating tube 52 into the gas separator 54 and is separated from the battery solution 12 by the gas separator 54. Thus separated gas is collected through the outlet duct 58 into a gas collecting tank (not shown) or the like.

An exhaust duct 60 is disposed at an end of the battery container 4 (more specifically, an upper end of the battery container 4 disposed aslant). The gas generated when the acceleration voltage is applied between the acceleration anode 18 and the acceleration cathode 20 is collected through the exhaust duct 60 into a gas collecting tank (not shown).

The battery device 2 is provided with various measuring instruments for monitoring various battery outputs. For example, in this embodiment, there are provided an electrolytic power measuring instrument 39 for measuring the electrolytic power from the electrolytic power source device 38, an acceleration power measuring instrument 41 for measuring the acceleration power from the acceleration power source device 40, and an external power measuring instrument 49 for measuring the external power (the battery output) extracted by the external power load 48.

As the battery solution 12, a mixture prepared by mixing an electrolytic solution with about 25 to 35 wt. % of heavy water or preferably about 30 to 35 wt. % of heavy water (for example, 34 wt. %) is used. As the electrolytic solution, a solution prepared by dissolving 0.005 to 0.05 mol of electrolytes per 1 litter of pure water (or distilled water) (0.005 to 0.05 mol/l) (0.01 mol/l, for example) is used. As the electrolytes, sodium hydroxide, potassium hydroxide, sodium carbonate, or the like is used.

Next, operation of the battery device 2 will be described. In order to extract the battery output, first the circulating pump 36 is activated. As a result, the battery solution 12 in the battery container 4 circulates through the solution circulation channel 28 and the reservoir 26. This flow of the battery solution 12 circulates the battery solution 12 in the battery container 4. As a result, the battery solution 12 is homogenized.

Next, the electrolytic power source device 38 is activated to apply the electrolytic voltage of about 2.5 to 5V (3V, for example) for example, between the electrolytic anode 14 and the electrolytic cathode 16. As a result, an electrolytic reaction occurs in the reservoir 26. Due to this electrolytic reaction, the battery solution 12 is ionized to generate positively charged ions. The battery solution 12 including the positively charged ions flows through the downstream part 34 of the solution circulation channel 28 into the battery container 4. At this time, the electrolytic reaction of the battery solution 12 generates a gas. Thus generated gas is discharged outside through the communicating tube 52, the gas separator 56, and the outlet duct 58.

Then, the acceleration power source device 40 is activated to apply an acceleration voltage of about 150 to 500 V, for example (200 V, for example) between the acceleration anode 18 and the acceleration cathode 20. As a result, the positively charged ions are accelerated and flow from the acceleration anode 18 to the acceleration cathode 20 within the battery solution 12 and collected to the acceleration cathode 20, increasing the energy density about the acceleration cathode 20. At this time, heavy hydrogen in the battery solution 12 flows within the battery container 4 due to this flow of the positively charged ions.

When the positively charged ions are collected to the acceleration cathode 20, then a negative charge as the collector charge flows toward the collecting cathode 24 for canceling out the positively charged ions. In other words, the collector charge (negative charge) flows from the collecting anode 22 to the collecting cathode 24 through the collector connection line 44. A part of this flow of the collector charge flows through the external power load 48, extracted as the battery output by the external power load 48, and consumed by the same.

### Second Embodiment

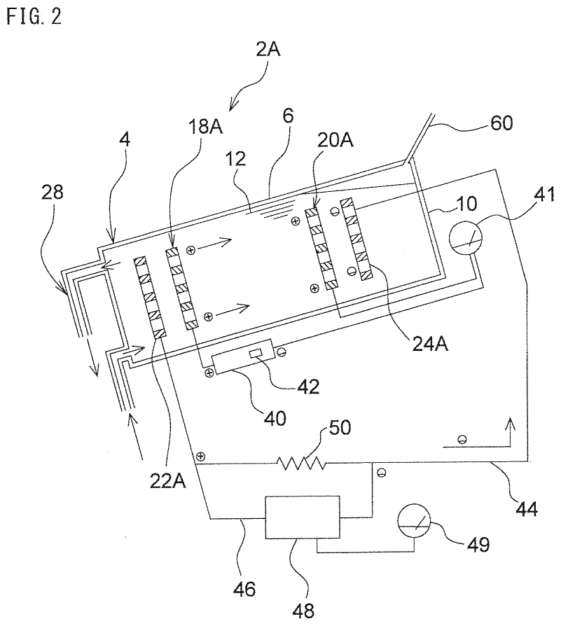

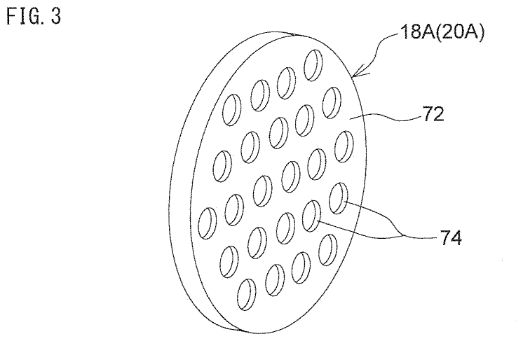

Next, a battery device according to a second embodiment of the invention will be described with reference to FIGS. 2 and 3. A battery device 2A according to the second embodiment is substantially the same as the above-described battery device 2, but differs in that anodes (an acceleration anode and a collector anode) and cathodes (an acceleration cathode and a collector cathode) are modified. In each of following embodiments, parts substantially the same as those of the above-described first embodiment are designated with the same numberings, and explanation thereof will be omitted.

As shown in FIG. 2, the battery device 2A includes an acceleration anode 18A and an acceleration cathode 20A. As shown in FIG. 3, each of the acceleration anode 18A and the acceleration cathode 20A includes a disk-shaped electrode body 72 formed with a plurality of through holes 74. The battery solution 12 in the battery container 4 flows through the through holes 74 of the acceleration anode 18A and the acceleration cathode 20A. The acceleration anode 18A is electrically connected to a positive side of the acceleration power source device 40, and the acceleration cathode 20A is electrically connected to a negative side of the acceleration power source device 40.

The battery device 2A also includes a collecting anode 22A and a collecting cathode 24A. Each of the collecting anode 22A and the collecting cathode 24A includes a disk-shaped electrode body (not shown) formed with a plurality of through holes (not shown) as the above-described acceleration anode 18A and the acceleration cathode 20A. The battery solution 12 flows through the through holes of the collecting anode 22A and the collecting cathode 24A. The collecting anode 22A and the collecting cathode 24A are electrically connected to each other through the collector connection line 44 disposed outside the battery container 4. The collector connection line 44 is electrically connected to the external power load 48 through the power output line 46. The collector connection line 44 is disposed with the variable resistance 50, and the power output line 46 is disposed electrically parallel to the variable resistance 50. The rest of the configuration of the battery device 2A of this embodiment is substantially the same as that of the above-described first embodiment.

In the battery device 2A of this second embodiment also, the above effects can be achieved because its basic structure is the same as that of the battery device 2 of the first embodiment. Also, because surface areas of the acceleration anode 18A and the acceleration cathode 20A are larger than those of the acceleration anode 18 and the acceleration cathode 20 of the first embodiment, the positively charged ions flow more from the acceleration anode 18A to the acceleration cathode 20A. As a result, the battery output is extracted more from the power output line 46.

### Third Embodiment

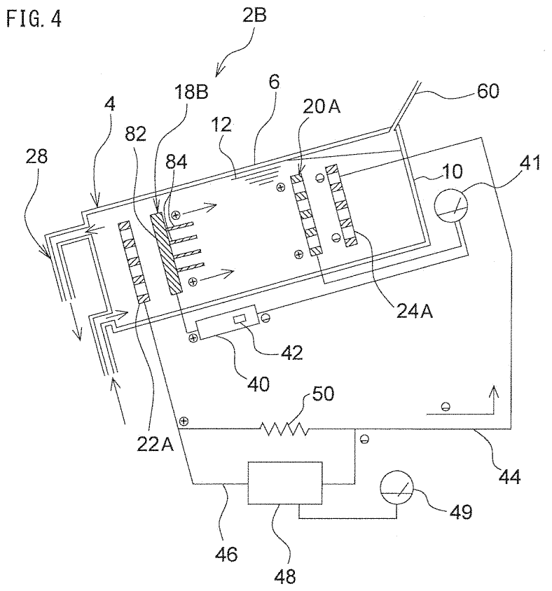

Next, a battery device according to a third embodiment of the invention will be described with reference to FIG. 4. A battery device 2B according to the third embodiment is substantially the same as the battery device 2A described above, but an acceleration anode is modified. That is, as shown in FIG. 4, the battery device 2B includes an acceleration anode 18B, and the acceleration anode 18B includes a disk-shaped electrode body 82 and a plurality of protruding electrode parts 84 which are disposed on a surface of the electrode body 82 (a surface confronting the acceleration cathode 20B) and spaced from one another. The protruding electrode parts 84 function as anode parts and protrude from the surface of the electrode body 82 toward the acceleration cathode 20B. The electrode body 82 is electrically connected to a positive side of the acceleration power source device 40, and the electrolytic voltage from the acceleration power source device 40 is applied to the electrode body 82 and the plurality of protruding electrode parts 84. The acceleration cathode 20A is electrically connected to a negative side of the acceleration power source device 40. The rest of the configuration of the battery device 2B is substantially the same as that of the above-described battery device 2A.

In the battery device 2B also, the above-described effects can be achieved because its basic structure is the same as that of the battery device 2, 2A. Also, compared to the battery device 2A, because the surface area of the acceleration anode 18B is larger, the positively charged ions flow more from the acceleration anode 18B to the acceleration cathode 20A, and thus the battery output of the battery device 2B is larger.

### Fourth Embodiment

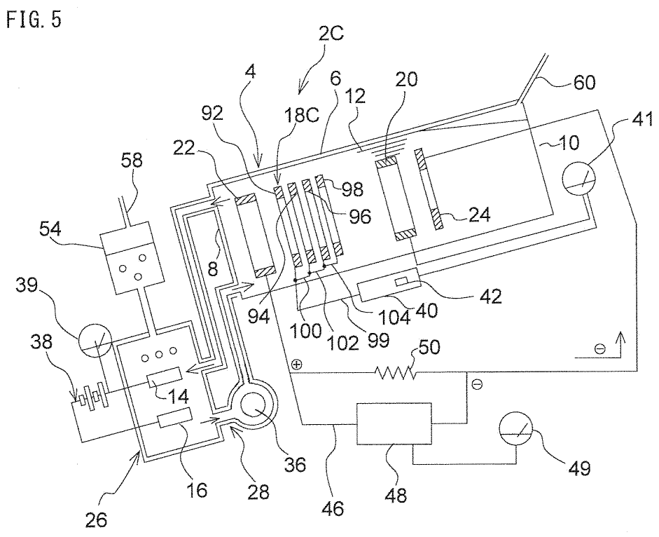

Next, a battery device according to a fourth embodiment of the invention will be described with reference to FIG. 5. A battery device 2C according to the fourth embodiment is substantially the same as the above-described battery device 2, but differs in that an acceleration anode is modified. As shown in FIG. 5, the battery device 2C of this embodiment includes an acceleration anode 18C, and the acceleration anode 18C includes a plurality of anode parts (four anode parts 92, 94, 96, 98 in the example shown in FIG. 5). The anode parts 92, 94, 96, 98 are ring-shaped electrode parts and disposed within the battery container 4 so as to confront one another with a space therebetween along the longitudinal direction of the battery container 4 (in a direction from the lower left to the upper right).

The first anode part 92 is electrically connected to the positive terminal of the acceleration power source device 40 through a first application line 99. The second anode part 94 is electrically connected to the first application line 99 through a second application line 100. The third anode part 96 is electrically connected to the second application line 100 through a third application line 102. The fourth anode part 98 is electrically connected to the third application line 102 through a fourth application line 104. Thus, the acceleration voltage from the acceleration power source device 40 is applied to the first to fourth anode parts 92, 94, 96, 98 through the first to fourth application lines 99, 100, 102, 104. The rest of the configuration of the battery device 2C is substantially the same as that of the battery device 2.

The battery device 2C also can achieve the above-described effects because its basic structure is the same as that of the battery device 2, 2A, 2B. Also, because the surface area of the acceleration anode 18C is made larger in the battery device 2C, the positively charged ions flow more from the acceleration anode 18C to the acceleration cathode 20.

### Fifth Embodiment

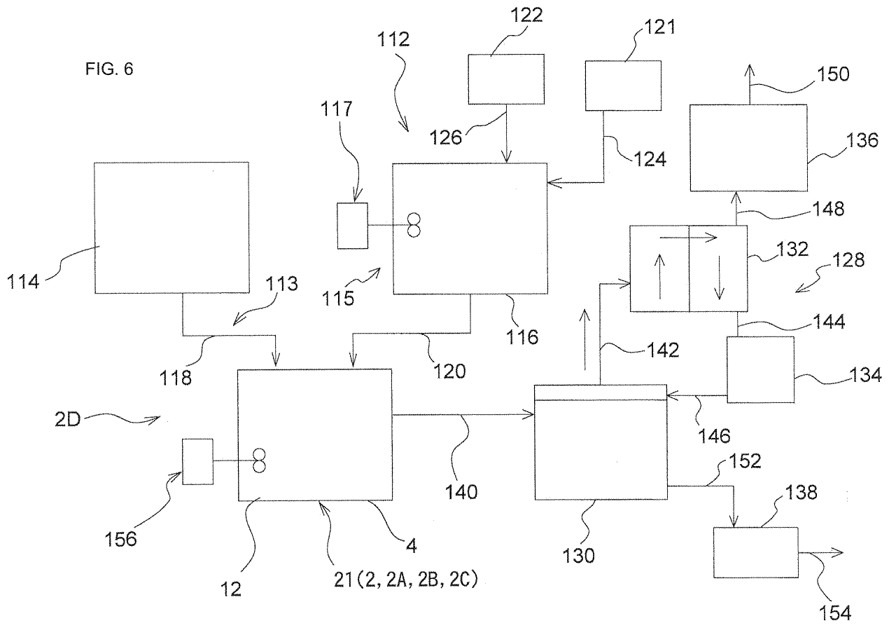

Next, a battery device according to a fifth embodiment of the invention will be described with reference to FIG. 6. A battery device 2D according to the fifth embodiment includes a battery apparatus 21 having the same configuration as any one of the above-described battery devices 2, 2A, 2C, 2C, a solution density adjusting device 112 disposed on a supply side of the battery container 4 of the battery apparatus 21, and a discharge device 128 disposed on a discharge side of the battery container 4. The solution density adjusting device 112 includes a heavy water supply device 113 for supplying heavy water to the battery container 4 and an electrolytic solution supply device 115 for supplying an electrolytic solution to the battery container 4.

The heavy water supply device 113 has a heavy water tank 114 for storing heavy water and a heavy water supply line 118 that connects the heavy water tank 114 to the battery container 4. Heavy water from the heavy water tank 114 is supplied to the battery container 4 through the heavy water supply line 118. The electrolytic solution supply device 115 includes an electrolytic solution tank 116 for storing the electrolytic solution. The electrolytic solution stored in the electrolytic solution tank 116 is supplied to the battery container 4 through an electrolytic solution supply line 120.

The electrolytic solution supply device 115 further includes an electrolyte container 121 containing electrolytes (for example, sodium hydroxide) and a pure water tank 122 that contains pure water. The electrolyte container 121 is connected to the electrolytic solution tank 116 through an electrolyte supply line 124, and the pure water tank 122 is connected to the electrolytic solution tank 116 through a pure water supply line 126. Also, the electrolytic solution tank 116 is provided with a stirring and mixing mechanism 118 for agitating and homogenizing the electrolytic solution. Thus, the electrolytes from the electrolyte container 121 are supplied to the electrolytic solution tank 116 through the electrolyte supply line 124, and the pure water from the pure water tank 122 is supplied to the electrolytic solution tank 116 through the pure water supply line 126. The pure water and the electrolytes supplied to the electrolytic solution tank 116 are stirred and mixed by the stirring and mixing mechanism 117 and homogenized.

The discharge device 128 is for discharging the battery solution and has a discharge tank 130 for storing the battery solution discharged from the battery container 4, a gas-liquid separator 132 for separating the battery solution into gas and liquid, a liquid collecting tank 134 for collecting the liquid separated in the gas-liquid separator 132, a gas processing device 136 for processing the gas separated in the gas-liquid separator 132 as needed, and a liquid processing device 138 for processing the battery solution from the discharge tank 130 as needed.

The battery container 4 and the discharge tank 130 are connected to each other by a discharge line 140. When the battery solution in the battery container 4 are changed in its component constitution or the like, then the battery solution in the battery container 4 is discharged into the discharge tank 130 through the discharge line 140. The discharge tank 130 and the gas-liquid separator 132 are connected to each other by a gas-liquid line 142. The gas from the discharge tank 130 is supplied to the gas-liquid separator 132 through the gas-liquid line 142. The liquid separated in the gas-liquid separator 132 (the liquid contained in the gas) is collected into the liquid collecting tank 134 through a liquid collecting line 144 and then returned to the discharge tank 130 through a liquid returning line 146. Also, the gas separated in the gas-liquid separator 132 is supplied to a gas processing device 136 through a gas discharging line 148, processed in the gas processing device 136 as required, and then collected into a gas collecting tank (not shown) through a gas discharge line 150. Also, the battery solution collected in the discharge tank 130 is sent to a liquid processing device 138 through a drainage line 152, processed in the liquid processing device 138 as needed, and collected into a reaction liquid collecting tank (not shown) through a liquid discharge line 154.

When the battery solution in the battery container 4 changes in its density, then the density of the battery solution is adjusted as described next. That is, when the battery solution in the battery container 4 changes in its component ratio (for example, when the mixing ratio of heavy water increases), then some of the battery solution in the battery container 4 is discharged into the discharge tank 130 through the discharge line 140 and processed as described above.

When the amount of the battery solution in the battery container 4 decreases in this manner, then the heavy water in the heavy water tank 114 is supplied into the battery container 4 through the heavy water supply line 118, and the electrolytic solution in the electrolytic solution tank 116 is supplied into the battery container 4 through the electrolytic solution supply line 120 and mixed with the battery solution in the battery container 4 by the operation of a homogenizing device 156 (for example, a device having a stirring blade for stirring the battery solution) and homogenized. At this time, a controlling device not shown in the drawings controls the amount of heavy water supply from the heavy water tank 114 and the amount of electrolytic solution supply from the electrolytic solution tank 116 so as to maintain the component ratio in the battery solution in the battery container 4 (mixing ratio between the heavy water and the electrolytic solution) within a predetermined range. As a result, the battery output of the battery device 2D is stabilized, and the operating time of the battery device 2D is elongated.

[Verification Experiment]

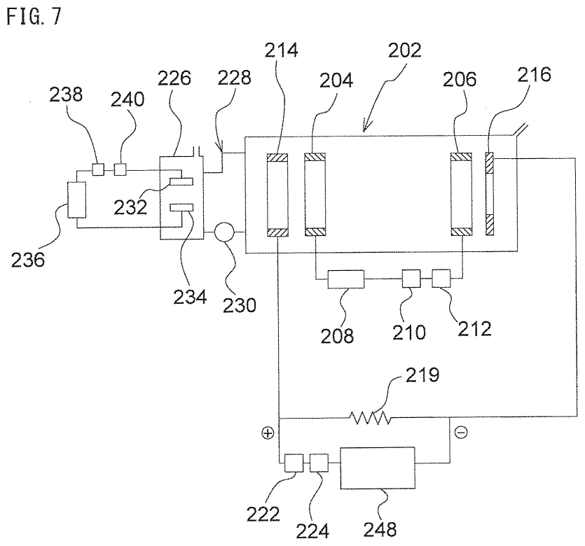

In order to verify the effects of the invention, a following verification experiment was conducted. A battery device used in this experiment has a configuration shown in FIG. 7. In FIG. 7, the battery device includes a battery container 202 for storing a battery solution. An acceleration anode 204 and an acceleration cathode 206 are disposed to confront each other within the battery container 202. The acceleration anode 204 and the acceleration cathode 206 are electrically connected to an acceleration power source device 208, and an acceleration voltage measuring instrument 210 and an acceleration electric current measuring instrument 212 are disposed for measuring an acceleration voltage and an acceleration electric current.

Also, a collector anode 214 is disposed outside the acceleration anode 204, and a collector cathode 216 is disposed outside the acceleration cathode 206. The collector anode 214 and the collector cathode 216 are electrically connected to an external power load 248 that is disposed electrically parallel to an electric resistance 219. An external voltage measuring instrument 222 and an external electric current measuring instrument 224 are disposed for measuring an external voltage (output voltage) and an external electric current (output electric current). It should be noted that an electric resistance of 200 ohm (Ω) is used as the external power load 248.

Further, a reservoir 226 is disposed outside the battery container 202. The battery container 202 and the reservoir 226 are connected to each other through a solution circulation channel 228, and a circulating pump 230 is disposed at the solution circulation channel 228, so that the battery solution in the battery container 202 circulates through the solution circulation channel 228 and the reservoir 226. Also, an electrolytic anode 232 and an electrolytic cathode 234 are disposed to confront each other within the reservoir 226. The electrolytic anode 232 and the electrolytic cathode 234 are electrically connected to an electrolytic power source device 236. An electrolytic voltage measuring instrument 238 and an electrolytic electric current measuring instrument 240 are disposed for measuring an electrolytic voltage and an electrolytic electric current. Plate-like electrodes are used as the electrolytic anode 232 and the electrolytic cathode 234. Ring-shaped electrodes are used as the acceleration anode 204, the acceleration cathode 206, and the collector anode 214.

In the experiment, the battery container 202 and the reservoir 226 were filled with the battery solution, and the electrolytic anode 232, the electrolytic cathode 234, the acceleration anode 204, the acceleration cathode 206, the collector anode 214, and the collector cathode 216 were immersed in the battery solution.

A solution prepared by dissolving 0.01 mol of sodium hydroxide in 1 litter of pure water was used as the electrolytic solution. The pH of the electrolytic solution used was 8.5. A solution prepared by mixing this electrolytic solution with heavy water was used as the battery solution. The mixing ratio of the heavy water was 34 wt. %.

In this condition where such battery solution was filled in the battery container 202, first the electrolytic power source device 236 applied the electrolytic voltage between the electrolytic anode 232 and the electrolytic cathode 234 to electrolyze the battery solution. The electrolytic voltage and the electrolytic electric current at this time were measured by the electrolytic voltage measuring instrument 238 and the electrolytic electric current measuring instrument 240 to be 3V and 3 A, respectively.

In this electrolyzing state (while the electrolytic voltage was being applied by the electrolytic power source device 236), the acceleration power source device 208 applied the acceleration voltage between the acceleration anode 204 and the acceleration cathode 206 such that the positively charged ions in the battery solution flows from the acceleration anode 204 to the acceleration cathode 206 through the battery solution. At this time, the acceleration voltage applied by the acceleration power source device 208 was set to 120 V while monitoring the measurement of the acceleration voltage measuring instrument 210. Then, the acceleration electric current in this state was measured to be 0.01 A by the acceleration electric current measuring instrument 212. Also, the output voltage (the external voltage) and the output electric current (external electric current) in this state were measured to be 60V and 0.1 A by the external voltage measuring instrument 222 and the external electric current measuring instrument 224, respectively. Thus, the output power at the external power load 248 (the electric resistance of 200Ω) was calculated to be 2 watts (W).

Next, in the above-described condition, the acceleration voltage applied by the acceleration power source device 208 was increased to 200 V while monitoring the measurement of the acceleration voltage measuring instrument 210. Then, the acceleration voltage in this condition was measured by the acceleration electric current measuring instrument 212 to be 0.02 A. Also, the output voltage (the external voltage) and the output electric current (the external electric current) in this state were measured to be 150 V and 0.5 A by the external voltage measuring instrument 222 and the external electric current measuring instrument 224. Thus, the output power of the external power load 248 (the electric resistance of 200Ω) is calculated to be 375 watts (W). This indicates that the output power greater than the input power of the acceleration power source device 208 can be obtained.

[Demonstration Experiment]

Also, a demonstration experiment was performed using a battery device having the same configuration as the battery device 2C shown in FIG. 5. In this demonstration experiment also, a solution prepared by dissolving 0.01 mol of sodium hydroxide per 1 litter of pure water was used as the electrolytic solution, and a solution prepared by mixing this electrolytic solution with 34 wt. % of heavy water was used as the battery solution.

Using the electrolytic power source device (38), an electrolytic voltage of 3 V was input between the electrolytic anode (14) and the electrolytic cathode (16). At this time, the electrolytic electric current was 2.5 V. Then, an acceleration voltage was applied between the acceleration anode (18C) and the acceleration cathode (20), and an output voltage at this time between the collecting anode (22) and the collecting cathode (24) was measured. When the acceleration voltage was increased to 126 V, the output voltage (in this case, the voltage value at the ends of the variable resistance of 2000Ω) was 69 V.

Using the results of this demonstration experiment, the following results were obtained through calculation of a relationship between the input power (the power of when the acceleration voltage was applied) and the output power (the power obtained between the collecting anode (22) and the collecting cathode (24)).

There is the following relationship between the electric current (I), the voltage (V), and the resistance (R):

electric current (I)=voltage (V)/resistance (R) (1)

The output voltage of 69 V and the resistance of 2000Ω are plugged into the above equation (1) to calculate the output electric current (Iₒᵤₜ) as follows.

Output electric current (Iₒᵤₜ)=69/2000=0.0345 (A)

Also, there is a following relationship between the power (W), the electric current (I), and the voltage (V):

power (W)=electric current (I)×voltage (V) (2)

Using the above equation (2), the output power (Vₒᵤₜ) is calculated as follows.

Output power (Wₒᵤₜ)=0.0345×69=2.3805 (W)

Thus, the output power (Wₒᵤₜ) is 2.3805 W.

When the output power is this, the input power (Wᵢₙ) (that is, the acceleration power) is obtained as follow. Assuming the input electric current (Iᵢₙ) (i.e., the acceleration electric current) is 0.002 A, then

input power (Wᵢₙ)=0.002×126=0.252 (W).

Thus, the input power (Wᵢₙ) is 0.252 W.

Therefore, a ratio (α) of the output power (Wₒᵤₜ) to the input power (Wᵢₙ) is calculated as follows.

Ratio (α)=2.3805/0.252≈9.446

That is, the output power (Wₒᵤₜ) about 9.446 times as much as the input power (Wᵢₙ) was obtained.

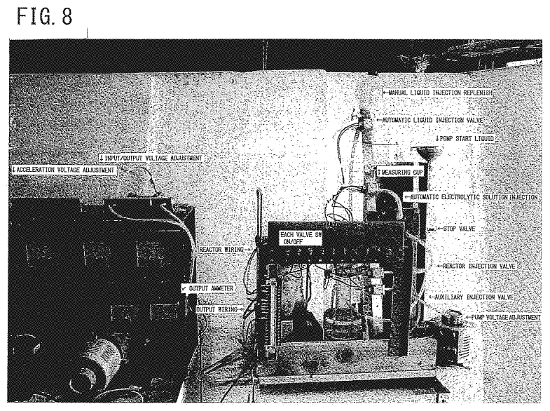

The applicant has completed a battery device shown in FIG. 8 by modifying the battery device used in the above demonstration experiment. Although demonstration experiments have not been performed with this battery device, the same experiment results as the same can be expected. In past experiments regarding battery devices, dangerous situations often occurred. The battery device has been modified to avoid such dangerous situations. The battery device shown in FIG. 8 has been thus modified and is capable of avoiding the dangerous situations in the past.

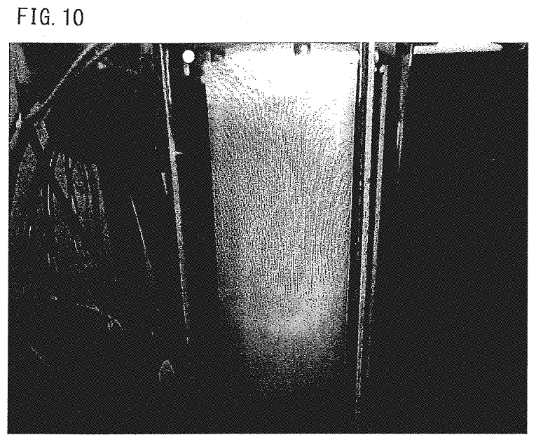

It should be noted that once in the past experiment, the battery solution in the battery container (near the acceleration cathode) became milky, threw small sparks, and entered a blow discharge state. Then, as shown in FIG. 10, it became dangerous with a flame generated on the upper side of the battery container like a small explosion.

This explosion phenomenon in the past was a violent one where flame flared up in the air about 100 mm. It is considered that this violent flame was energy due to the flow of charges flown into the air and appeared as the flame. This phenomenon suggests the followings. That is, the large amount of energy generated in this battery device is used to convert water into heavy water, and the output power generated in this experiment was only a portion of the large amount of energy generated. When the battery solution was examined after the experiment, the ratio of the battery solution was found increased. This increase in the ratio is considered as a proof that the water was converted into heavy water.

### EXPLANATION OF THE NUMBERINGS

2, 2A, 2B, 2C, 2D battery device
4, 4A, 4B, 4D, 202 battery container
12 battery solution
14, 232 electrolytic anode
16, 234 electrolytic cathode
18, 18A, 18B, 18C, 204 acceleration anode
20, 20A, 20B, 206 acceleration cathode
22, 22A, 22B collecting anode
24, 24A, 24B collecting cathode
26, 226 reservoir
28, 228 solution circulation channel
38, 238 electrolytic power source device
40, 248 acceleration power source device
42 acceleration voltage adjustor
48, 248 external power load
92, 94, 96, 98 anode part
112 solution density adjusting device
113 heavy water supply device
115 electrolytic solution supply device
128 discharge device

1. A battery device comprising;
a battery container that stores a battery solution including an electrolytic solution and a heavy water;
an electrolytic anode and an electrolytic cathode that electrolyze the battery solution to ionize the electrolytic solution, thereby generating positively charged ions;
an electrolytic power source device that applies an electrolytic voltage between the electrolytic anode and the electrolytic cathode;
an acceleration anode and an acceleration cathode disposed within the battery container that accelerate and make the positively charged ions in the battery solution move;
an acceleration power source device that applies an acceleration voltage between the acceleration anode and the acceleration cathode; and
a collecting anode and a collecting cathode for collecting charges, wherein:
the collecting anode is disposed outside the acceleration anode;
the collecting cathode is disposed outside the acceleration cathode;
the collecting anode and the collecting cathode are electrically connected to each other through a collector connection line disposed outside the battery container; and
when an acceleration voltage is applied between the acceleration anode and the acceleration cathode, then the positively charged ions flow from the acceleration anode to the acceleration cathode and gather at the acceleration cathode, and a collector charge flows from the collecting anode to the collecting cathode through the collector connection line for canceling out the positively charged ions gathered at the acceleration cathode, and a part of the collector charge flowing through the collector connection line is extracted as a battery output.

2. The battery device according to claim 1, further comprising a homogenizing device that homogenizes the battery solution, wherein:
the homogenizing device includes a reservoir disposed outside an end wall of the battery container, a solution circulation channel for circulating the battery solution through the reservoir, and a circulating pump disposed to the solution circulation channel;
the battery solution in the battery container circulates through the solution circulation channel and the reservoir, and the flow of the battery solution circulating through the solution circulation channel circulates the battery solution in the battery container.

3. The battery device according to claim 2, wherein:
the electrolytic anode and the electrolytic cathode are disposed in the reservoir; and
the battery solution is electrolyzed in the reservoir and sent into the battery container through the solution circulation channel.

4. The battery device according to claim 2, further comprising a solution density adjusting device for maintaining the density of the battery solution within a predetermined range, wherein:
the solution density adjusting device includes an electrolytic solution supply device that supplies the electrolytic solution, a heavy water supply device that supplies the heavy water, and a discharge device that drains the battery solution in the battery container.

5. The battery device according to claim 4, wherein:
the acceleration power source device has an acceleration voltage adjustor that adjusts the acceleration voltage; and
the acceleration voltage adjustor adjusts the acceleration voltage such that a voltage of the battery output becomes lower than the acceleration voltage.

6. The battery device according to claim 5, wherein the acceleration anode has a plurality of anode parts disposed in the battery container to be spaced from one another, and each of neighboring pairs of anode parts is electrically connected to each other.

7. The battery device according to claim 6, wherein a mixing ratio of the heavy water in the battery solution is 25 to 35% by weight.

8. The battery device according to claim 1, wherein:
the acceleration power source device has an acceleration voltage adjustor that adjusts the acceleration voltage; and
the acceleration voltage adjustor adjusts the acceleration voltage such that a voltage of the battery output becomes lower than the acceleration voltage.

9. The battery device according to claim 1, wherein the acceleration anode has a plurality of anode parts disposed in the battery container to be spaced from one another, and each of neighboring pairs of anode parts is electrically connected to each other.

10. The battery device according to claim 1, wherein a mixing ratio of the heavy water in the battery solution is 25 to 35% by weight.
